(19) United States
(12) Patent Application Publication
(10) Pub. No.: US 2026/0309878 A1
(43) Pub. Date: Oct. 8, 2026

(54) METHOD OF INJECTING CHARGE INTO VDMOS DEVICE, METHOD OF DETECTING RADIATION DOSE AND ELECTRONIC DEVICE

(71) Applicant: Nuctech Company Limited, Beijing (CN)

(72) Inventors: Wenjian ZHANG, Beijing (CN); Xingliang ZHAI, Beijing (CN); Shuwei LI, Beijing (CN)

(21) Appl. No.: 19/255,740

(22) Filed: Jun. 30, 2025

(30) Foreign Application Priority Data
Oct. 12, 2024 (CN) 202411425856.3

(51) Int. Cl. G01T 1/185; G01T 1/14

(52) U.S. Cl. CPC G01T 1/185; G01T 1/14

(57) ABSTRACT

The present disclosure provides a method of injecting a charge into a VDMOS device and a method of detecting a radiation dose. The charge injection method includes: arranging N VDMOS devices in an ionization chamber, a gate of the VDMOS device is a floating gate, the ionization chamber defines a space, and N≥1; filling the space with gas, the gas reacts with a ray entering the space to generate negative and positive charges; providing the ray to the ionization chamber, so the gas is ionized into the negative and positive charges; applying a first voltage to the ionization chamber, the first voltage forms a first electric field with a first direction in the space, so the positive charge is injected into the floating gate of the VDMOS device, the first direction is a direction in which the floating gate towards a bottom surface of the ionization chamber.

### CROSS REFERENCE TO RELATED APPLICATION

This application claims priority to Chinese Patent Application No. 202411425856.3, filed on Oct. 12, 2024, the entire content of which is incorporated herein in its entirety by reference.

### TECHNICAL FIELD

The present disclosure relates to a field of radiation measurement, and in particular to a method of injecting a charge into a VDMOS device, a method of detecting a radiation dose, an electronic device, a storage medium and a computer program product.

### BACKGROUND

A radiation dosimeter may be widely used in fields of nuclear physics, medicine, environmental monitoring, radiation protection, aerospace, etc. At present, the domestic mainstream uses a thermos-luminescence dosimeter (TLD) as a personal and environmental dosimeter. However, an operation of a TLD technology is complicated, in which a thermos-luminescence emitter needs to be replaced regularly and a specialized dose reading device is required, so it is difficult to achieve online real-time reading. In the related art, the TLD dosimeter is replaced with a DIS dosimeter for radiation dose detection. The DIS dosimeter may easily achieve a low-dose (μSv-level) dose detection, and may be miniaturized with a current highly integrated chip technology, which has obvious technical advantages in terms of consumables, operating skill requirements, measurement and reading environment, measurement and reading repeatability, zero clearing mode, upper limit of dose measurement, lower limit of energy range, etc. Furthermore, the DIS dosimeter is a self-sufficient detector without power supply from a power supply battery, which has obvious practical advantages.

Generally, the DIS dosimeter needs to pre-apply a voltage of about 30 V to a drain electrode D and a source electrode S of a VDMOS device, and injects a certain amount of charges into a floating gate through an electron tunneling effect. When the DIS dosimeter is irradiated, a ray may ionize a charge in an ionization chamber, and the ionized charge may be collected by the floating gate under an action of an external electric field of the ionization chamber and neutralize a preset voltage. Cumulative dose information may be obtained by measuring a variation of the preset voltage.

However, the VDMOS device usually performs a gate charge injection by using an F-N tunneling effect, so as to obtain a preset voltage V₀ at a gate electrode of the VDMOS device. When the gate charge injection is performed by using the F-N tunneling effect, an injection voltage is usually between 20 V to 30 V, and a specialized device is required for the gate charge injection before leaving the factory. When the gate charge injection is performed by using the F-N tunneling effect, it is required that the VDMOS device has an extremely thin gate oxide, and a special VDMOS device manufacturing process must be used. Such method requires a high manufacturing cost, and due to a high injection voltage, it is difficult to achieve the gate charge injection of the VDMOS device on the whole DIS dosimeter, and it is not easy to accurately control the number of charges injected into the gate electrode.

### SUMMARY

In view of this, the present disclosure provides a method of injecting a charge into a VDMOS device, a method of detecting a radiation dose, an electronic device, a storage medium and a computer program product.

An aspect of the present disclosure provides a method of injecting a charge into a VDMOS device, including:
arranging N VDMOS devices in an ionization chamber, where a gate electrode of the VDMOS device is a floating gate, the ionization chamber is configured to define an accommodation space, and N is a positive integer greater than or equal to 1;
filling the accommodation space with gas, where the gas is configured to react with a ray entering the accommodation space to generate a negative charge and a positive charge;
providing the ray to the ionization chamber, such that the gas is ionized into the negative charge and the positive charge; and
applying a first voltage to the ionization chamber, where the first voltage is configured to form a first electric field with a first electric field direction in the accommodation space, such that the positive charge is injected into the floating gate of the VDMOS device, where the first electric field direction is a direction in which the floating gate towards a bottom surface of the ionization chamber.

According to embodiments of the present disclosure, a voltage value of the first voltage is in a range of 5 V to 10 V.

According to embodiments of the present disclosure, when a value of N is greater than or equal to 2, gate electrodes of at least part of the N VDMOS devices are configured to receive the positive charge.

According to embodiments of the present disclosure, the gate electrodes of the N VDMOS devices are cascaded by a conductive metal wire, and the metal wire is configured to receive the positive charge and inject the positive charge into the gate electrode of at least one VDMOS device.

Another aspect of the present disclosure provides a method of detecting a radiation dose, including:
providing an ionization chamber and N VDMOS devices, where a gate electrode of the VDMOS device is a floating gate, the ionization chamber is configured to define an accommodation space, and N is a positive integer greater than or equal to 1;
pre-injecting a positive charge into floating gates of the N VDMOS devices by using the method as described above, so as to form a preset voltage on the floating gates of the N VDMOS devices;
enabling the ionization chamber to receive a to-be-detected ray, such that gas is ionized into a negative charge and a positive charge;
applying a second voltage to the ionization chamber, where the second voltage is configured to form a second electric field with a second electric field direction in the accommodation space, such that the negative charge is injected into the floating gate of the VDMOS device to neutralize a pre-injected positive charge, where the second electric field direction is opposite to the first electric field direction; and
detecting a variation of the preset voltage of at least one of the N VDMOS devices to obtain a radiation dose of the to-be-detected ray.

According to embodiments of the present disclosure, a voltage value of the second voltage is in a range of 5 V to 10 V.

According to embodiments of the present disclosure, a voltage value of the second voltage is substantially equal to a voltage value of the first voltage.

According to embodiments of the present disclosure, the detecting a variation of the preset voltage of at least one of the N VDMOS devices to obtain a radiation dose of the to-be-detected ray includes:
detecting a change of a source-drain reverse current-voltage curve of at least one of the N VDMOS devices, so as to obtain the radiation dose of the to-be-detected ray.

According to embodiments of the present disclosure, when a value of N is greater than or equal to 2, the N VDMOS devices include a main VDMOS device and N-1 auxiliary VDMOS devices; and
the radiation dose of the to-be-detected ray is obtained by the source-drain reverse current-voltage curve of the main VDMOS device before and after a change.

Another aspect of the present disclosure provides an electronic device, including:
one or more processors; and
a memory configured to store one or more programs,
where the one or more programs, when executed by the one or more processors, are configured to cause the one or more processors to implement the method of injecting a charge into a VDMOS device as described above or the method of detecting a radiation dose as described above.

Another aspect of the present disclosure provides a computer-readable storage medium having computer-executable instructions stored therein, where the instructions, when executed, are configured to implement the method of injecting a charge into a VDMOS device as described above or the method of detecting a radiation dose as described above.

Another aspect of the present disclosure provides a computer program product including computer-executable instructions, where the instructions, when executed, are configured to implement the method of injecting a charge into a VDMOS device as described above or the method of detecting a radiation dose as described above.

### BRIEF DESCRIPTION OF THE DRAWINGS

The above and other objectives, features, and advantages of the present disclosure will be more apparent through the following description of embodiments of the present disclosure with reference to accompanying drawings, in which:

FIG. 1 schematically shows a schematic structural diagram of a VDMOS device according to embodiments of the present disclosure;

FIG. 2 schematically shows a structural diagram of an apparatus of detecting radiation dose according to embodiments of the present disclosure;

FIG. 3 is a flowchart of a method of injecting a charge into a VDMOS device according to embodiments of the present disclosure;

FIG. 4 is a schematic plan view of injecting a charge into a VDMOS device according to embodiments of the present disclosure;

FIG. 5 is a schematic plan view of injecting a charge into a VDMOS device according to other embodiments of the present disclosure;

FIG. 6 is a flowchart of a method of detecting a radiation dose according to embodiments of the present disclosure;

FIG. 7 is a schematic plan view of an apparatus of detecting a radiation dose for detecting a ray according to embodiments of the present disclosure;

FIG. 8 is a schematic plan view of an apparatus of detecting a radiation dose for detecting a ray according to other embodiments of the present disclosure; and

FIG. 9 schematically shows a block diagram of an electronic device suitable for implementing a method of injecting a charge into a VDMOS device or a method of detecting a radiation dose according to embodiments of the present disclosure.

It should be noted that, for the sake of clarity, in the accompanying drawings used to describe embodiments of the present disclosure, a size of a whole/partial structure or a whole/partial region may be enlarged or reduced, that is, these accompanying drawings may not be drawn to actual scales.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed descriptions, for the convenience of explanation, many specific details are set forth to provide a comprehensive understanding of embodiments of the present disclosure. However, it is obvious that one or more embodiments may be implemented without these specific details. In addition, in the following description, descriptions of well-known structures and technologies are omitted to avoid unnecessarily obscuring the concept of the present disclosure.

Terms used herein are only intended to describe specific embodiments and are not intended to limit the present disclosure. Terms “include”, “comprise”, “contain”, etc. used herein indicate the presence of the described features, steps, operations and/or components, but do not exclude the presence or addition of one or more other features, steps, operations and/or components.

All terms (including technical and scientific terms) used herein have meanings generally understood by those of ordinary skilled in the art, unless otherwise defined. It should be noted that the terms used herein should be interpreted as having the meaning consistent with the context of the present disclosure, and should not be interpreted in an idealized or overly rigid manner.

First, some terms involved in the present disclosure are explained as follows:
DIS dosimeter: a radiation dosimeter combining an ionization chamber and a VDMOS technology;
TLD: thermo-luminescence dosimeter;
VDMOS: vertical double diffusion metal oxide semiconductor;
source-drain reverse current-voltage curve: influenced by a source-drain reverse I-V characteristic, a trend of a current between a source and a drain changing with a voltage between the source and the drain characterized by a curve;
breakdown voltage: a voltage of a diode between a drain and a source when avalanche breakdown occurs. When a voltage of a gate electrode is 0, a channel between the drain and the source is pinched off, and when a current provided between the drain and the source may make a reverse bias electric field of the diode continuously increase, the avalanche breakdown occurs;
IDS: a current value measured between the drain and the source by providing a voltage to a drain electrode after a power semiconductor device is turned off.

Embodiments of the present disclosure provide a method of injecting a charge into a VDMOS device, including: arranging N VDMOS devices in an ionization chamber, where a gate electrode of the VDMOS device is a floating gate, the ionization chamber is used to define an accommodation space, and N is a positive integer greater than or equal to 1; filling the accommodation space with gas, where the gas is configured to react with a ray entering the accommodation space to generate a negative charge and a positive charge; providing the ray to the ionization chamber, such that the gas is ionized into the negative charge and the positive charge; and applying a first voltage to the ionization chamber, where the first voltage is used to form a first electric field with a first electric field direction in the accommodation space, such that the positive charge is injected into the floating gate of the VDMOS device, where the first electric field direction is a direction in which the floating gate towards a bottom surface of the ionization chamber.

By adding a selection path to the ionization chamber, a voltage of the ionization chamber may be adjusted hierarchically. An integrated charge injection function of a dosimeter may be achieved by using a reverse polarity of power supply for a dosimeter ionization chamber. By using a method of injecting a charge by ionization, a requirement for a gate oxide insulating layer in the VDMOS device may be reduced, and factors such as a thickness and a quality of the gate oxide insulating layer, etc. do not need to be considered, thereby reducing a manufacturing difficulty of the VDMOS device, and the manufacturing may be completed by using a standard VDMOS process. In addition, by monitoring a variation of the preset voltage during radiation charge injection, an amount of injected charges may be accurately determined, so as to achieve an accurate charge injection.

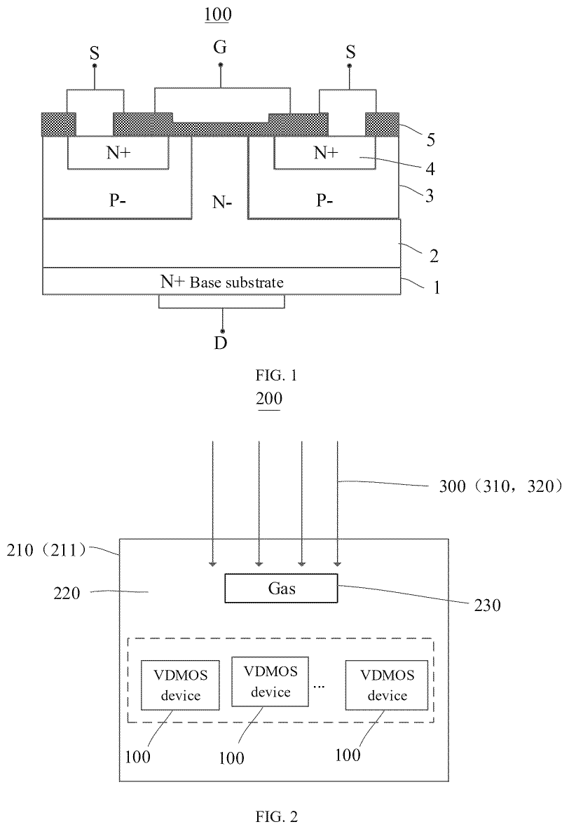

The technical solutions of the method of injecting a charge into a VDMOS device and the method of detecting a radiation dose in embodiments of the present disclosure will be described below with reference to FIG. 1 to FIG. 8.

FIG. 1 schematically shows a schematic structural diagram of a VDMOS device according to embodiments of the present disclosure.

FIG. 1 shows a VDMOS device 100 with a double diffusion structure of vertical conduction. In the VDMOS device 100, an (N−) epitaxial layer 2 is epitaxially grown on an (N+) base substrate 1, then two diffusions of (P−)-type and (N+)-type are successively performed on the (N−) epitaxial layer 2 to form a (P−)-type region 3 and an (N+)-type region 4, then a source electrode S and a gate electrode G are led out from an upper surface, and a drain electrode D is led out from the back of the (N+) base substrate 1. The (P−)-type region 3 between the (N+)-type region 4 and an (N−)-type region 2 is a channel. The source electrode S and the drain electrode D may be connected through the (N+)-type region 4, the (P−)-type region 3 and the (N−) epitaxial layer 2, and a punch-through between the source and the drain may be avoided.

The VDMOS device 100 may further include a gate oxide insulating layer 5 located between the gate electrode G and the (N−) epitaxial layer 2. For example, a material of the gate oxide insulating layer 5 may include SiO₂.

Referring to FIG. 1, a working principle of the VDMOS device 100 is as follows. When a power supply voltage V_{DS} is applied between the source electrode S and the drain electrode D, if a potential of the gate electrode G is 0 or negative, there is no current between the source electrode S and the drain electrode D due to a reverse bias of a PN junction, that is, IDS=0. When a positive voltage is applied to the gate electrode G, electrons may be induced and continuously accumulated in the (P−)-type region 3, thereby forming an N-channel. The N-channel connects the (N+)-type region 4 located above and the (N−) epitaxial layer 2 located below, and a current IDS is generated between the source electrode S and the drain electrode D. A magnitude of the current depends on a magnitude of the positive voltage on the gate electrode G.

It should be noted that, FIG. 1 shows an exemplary VDMOS device 100 structure. However, embodiments of the present disclosure are not limited thereto. The VDMOS device 100 of embodiments of the present disclosure may include a planar VDMOS device, a vertical VDMOS device, or VDMOS devices with other structures.

FIG. 2 schematically shows a structural diagram of an apparatus 200 of detecting a radiation dose according to embodiments of the present disclosure.

In some embodiments, the apparatus 200 of detecting a radiation dose may be a DIS dosimeter. As shown in FIG. 2, the apparatus 200 of detecting a radiation dose may include an ionization chamber 210 and N VDMOS devices 100, where N is an integer greater than or equal to 1.

The ionization chamber 210 is an instrument for measuring a radiation dose. energy and an intensity of radiation may be measured by using a charged particle produced by an interaction between radiation and matter. The radiation dose refers to an amount of radiation energy received by human body or object. The radiation dose may come from natural radiation, an artificial radioactive source, a nuclear facility accident, etc. In either case, it may have different degrees of impact on the human body.

For example, the ionization chamber 210 generally includes a metal housing 211, and the metal housing 211 defines an accommodation space 220. The accommodation space 220 is filled with gas 230, and the gas 230 is configured to react with a ray 300 entering the accommodation space 230 to generate a negative charge and a positive charge. For example, when the ray 300 is incident into the gas 230, an atom or a molecule in the gas 230 may be ionized to generate a free electron and a positive ion.

For example, the ray 300 may include at least one of a ray 310 for a charge injection of the gate electrode G in the VDMOS device 100 and a to-be-detected ray 320.

For example, N VDMOS devices 100 are placed in the accommodation space 220, and a charge may be pre-injected into the gate electrode G in the VDMOS device 100 to form a preset voltage V₀. The preset voltage V₀ is a key parameter for a subsequent detection of a dose of a radiation ray.

For example, when the to-be-detected ray 320 is incident in the gas, it may interact with an atom or a molecule of the gas, thereby generating ionization, which may generate a free electron and a positive ion pair. By applying an external electric field in the ionization chamber, the free electron may be controlled to move to the gate electrode G of the VDMOS device 100. The free electron may neutralize the pre-injected positive charge, thereby changing an amount of charges of the gate electrode G, and further changing a voltage value of the preset voltage V₀, such that a source-drain reverse I-V characteristic of the VDMOS device 100 may be obviously changed. For example, the free electron generated by the to-be-detected ray and the gas moves to the gate electrode G of the VDMOS device 100 under an action of the external electric field, which may neutralize the pre-injected positive charge, thereby leading to a decrease of the voltage value of the preset voltage V₀. The decrease of the preset voltage V₀ may lead to a change of a current IDS between the source electrode S and the drain electrode D. By detecting a variation of the current IDS between the source electrode S and the drain electrode D, a variation of charges on the gate electrode G of the VDMOS device 100 may be obtained, so as to obtain the radiation dose.

In some embodiments, a source-drain reverse current-voltage curve of at least one of the N VDMOS devices 100 changes in response to the electron, and the radiation dose of the ray is obtained from the source-drain reverse current-voltage curve before and after the change.

In some embodiments, the above-mentioned gas may include a first working gas configured to react with a ray entering the accommodation space 220 to generate a negative charge and a positive charge, and the ray may include at least one of an X-ray, an α-ray, a γ-ray and a β-ray. For example, the first working gas includes air, inert gas, etc., such as one or more of He, Ne, Ar, Kr, Xe, air, etc. The accommodation space 220 may be a closed space. For example, the gas may have an ionization effect with one or more rays (such as at least one of the X-ray, the α-ray, the γ-ray and the β-ray) in the closed space to generate the negative charge and the positive charge.

In other embodiments, the above-mentioned gas may include a second working gas configured to react with a neutron beam entering the accommodation space 220 to generate a negative charge and a positive charge, and/or the ionization chamber 210 is configured to coat at least one sidewall of the accommodation space 220 with a neutron sensitive material layer. The neutron sensitive material layer is configured to react with the neutron beam entering the accommodation space 220 to generate the negative charge and the positive charge.

For example, gas such as helium (He₃), boron trifluoride (BF₃), etc. which undergo a nuclear reaction with the neutron beam and generate a charged particle may be used as the second working gas. Boron (B), lithium (Li), gadolinium (Gd) and uranium-235 (U235) may be coated as neutron sensitive material layers, which may play the same ionization role with undergoing a nuclear reaction with the neutron beam to generate the charged particle, thereby detecting the neutron beam and expanding an application scenario.

It may be understood that the scope of protection of the present disclosure is not limited to the X-ray, the α-ray, the γ-ray, the β-ray and the neutron beam. On the basis of achieving a detection of the radiation dose by combining the ionization chamber and a VDMOS technology using the inventive concept of the present disclosure, the accommodation space may be filled with a corresponding type of gas that reacts to generate an electron for a detected ray, or a corresponding type of material that reacts to generate an electron may be coated on a sidewall of the accommodation space.

In embodiments of the present disclosure, by combining the ionization chamber 210 and the VDMOS technology, a low-dose (such as μSv-level) dose detection may be conveniently achieved by using a low-dose sensitivity characteristic of the ionization chamber 210 without frequently replacing the VDMOS device 100, which may have a high adaptability to various measurement and reading environments. Furthermore, based on the ionization chamber 210 and the VDMOS technology, an electrical signal may be directly output, which may easily obtain the source-drain reverse current-voltage curve by combining with electronic hardware so as to achieve an effect of directly reading the radiation dose, thereby reducing a requirement for an operational skill and improving a repeatability of measurement and reading.

In some embodiments, the obtaining the radiation dose of the ray from the source-drain reverse current-voltage curve before and after the change includes: determining at least one of a current change value, a voltage change value and a breakdown voltage change value before and after irradiation through the source-drain reverse current-voltage curve before and after the change, so as to obtain the radiation dose of the ray. For example, a corresponding relationship between the radiation dose of the ray and at least one of the current change value, the voltage change value and the breakdown voltage change value before and after irradiation is determined, and a radiation dose value of the to-be-detected ray is obtained through at least one of a current, a voltage and a breakdown voltage.

According to embodiments of the present disclosure, a change of at least one of the current, the voltage and the breakdown voltage caused by rays with different radiation doses may be considered, and the radiation dose of the ray may be tested, which may improve a convenience and an accuracy of detection.

In the related art, the VDMOS device usually performs a gate charge injection by using an F-N tunneling effect, so as to obtain the preset voltage V₀ at the gate electrode of the VDMOS device. When the gate charge injection may be performed by using the F-N tunneling effect, an injection voltage is usually between 20 V to 30 V, and a specialized device is required for the gate charge injection before leaving the factory. When the gate charge injection may be performed by using the F-N tunneling effect, it is required that the VDMOS device has an extremely thin gate oxide, and a special VDMOS device manufacturing process must be used. Such method requires a high manufacturing cost, and due to a high injection voltage, it is difficult to achieve the gate charge injection of the VDMOS device on the whole DIS dosimeter, and it is not easy to accurately control the number of charges injected into the gate electrode.

Through research, the inventor has found that the ionized positive charge may be injected into the gate electrode of the VDMOS device by using the positive charge generated by the ionization of the ray and the gas in the accommodation space 220 and then controlling an external voltage of the ionization chamber to be reversed, such that the preset voltage V₀ may be obtained at the gate electrode of the VDMOS device.

According to embodiments of the present disclosure, the external electric field may be used to provide a reverse electric field to the ionization chamber 210, such that the positive charge may be injected into the gate electrode of the VDMOS device under an action of the reverse electric field, thereby achieving a gate charge injection function of the VDMOS device under a condition of an integrated dosimeter. Through such a design, a variation of the preset voltage may be monitored during radiation charge injection, such that an injected charge amount may be accurately determined and an accurate charge injection may be achieved. Moreover, the method may reduce a requirement for a gate oxide insulating layer in the VDMOS device, and parameters such as a thickness, a quality, etc. of the gate oxide insulating layer do not need to be considered, thereby reducing a manufacturing difficulty of the VDMOS device. The manufacturing may be completed by using a standard VDMOS process.

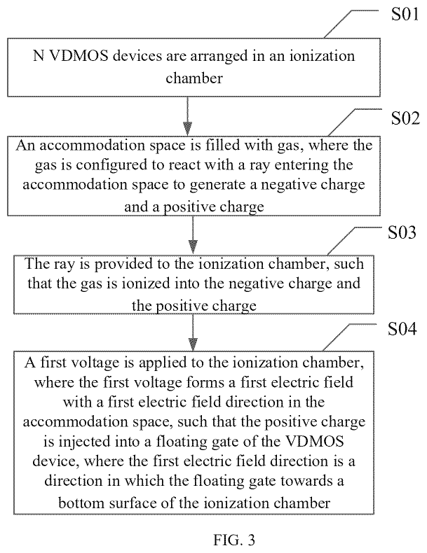

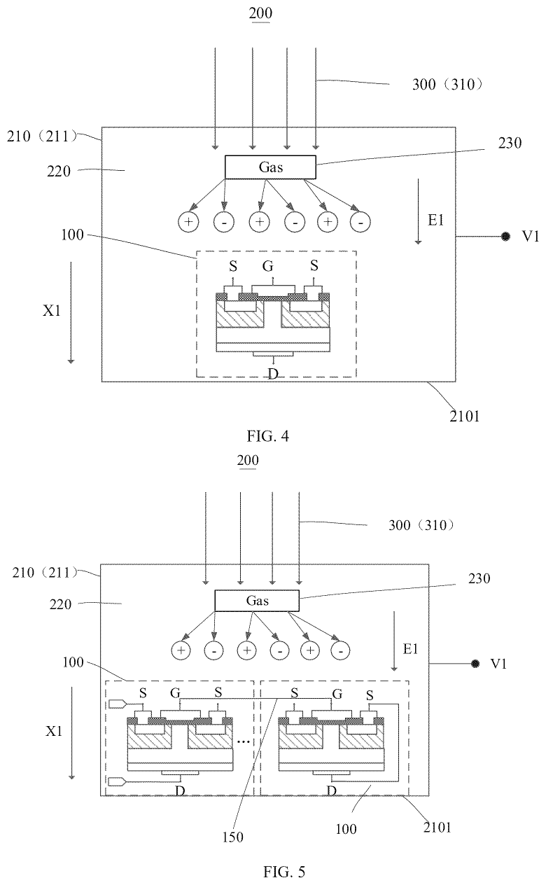

FIG. 3 is a flowchart of a method of injecting a charge into a VDMOS device according to embodiments of the present disclosure; FIG. 4 is a schematic plan view of injecting a charge into a VDMOS device according to embodiments of the present disclosure; and FIG. 5 is a schematic plan view of injecting a charge into a VDMOS device according to other embodiments of the present disclosure.

For example, in embodiments of the present disclosure, referring to FIG. 3 to FIG. 5, a method of injecting a charge into a VDMOS device is provided. The method may include the following steps S01 to S04.

In the step S01, N VDMOS devices 100 are arranged in the ionization chamber 210. The gate electrode G of the VDMOS device 100 is a floating gate, thereby facilitating injecting a charge into the gate electrode. The ionization chamber 210 is used to define the accommodation space 220, where N is a positive integer greater than or equal to 1.

For example, the ionization chamber 210 includes a bottom surface 2101, and the VDMOS device 100 may be arranged on the bottom surface 2101 of the ionization chamber 210. The gate electrode G of the VDMOS device 100 may be located on a side of the VDMOS device 100 away from the bottom surface 2101 of the ionization chamber.

In the step S02, the accommodation space 220 is filled with the gas 230, and the gas 230 is configured to react with the ray 300 entering the accommodation space to generate a negative charge and a positive charge.

In the step S03, the ray 300 is provided to the ionization chamber, such that th gas 230 is ionized into the negative charge and the positive charge. For example, the ray 300 may include the ray 310 for the gate charge injection in the VDMOS device 100.

In the step S04, referring to FIG. 4, a first voltage V1 is applied to the ionization chamber 210. The first voltage V1 may form a first electric field E1 with a first electric field direction X1 in the accommodation space 220. Under an action of the first electric field E1, the positive charge moves towards a direction close to the floating gate of the VDMOS device, such that the positive charge is injected into the floating gate of the VDMOS device 100. The first electric field direction X1 is a direction in which the gate electrode G faces the bottom surface 2101 of the ionization chamber 210. For example, the VDMOS device is a P-type VDMOS device, and under an action of an external electric field, an ionized positive charge may be injected into the gate electrode of the VDMOS device 100 along a power line.

By adjusting the external electric field applied to the ionization chamber, the positive charge may be pre-injected into the gate electrode G of the VDMOS device in an integrated apparatus 200 of detecting a radiation dose, thereby forming the preset voltage V₀, so as to facilitate achieving a radiation dose detection of the to-be-detected ray subsequently.

For example, a voltage value of the first voltage V1 is in a range of 5 V to 10 V. For example, the voltage value of the first voltage V1 is 6 V.

For example, referring to FIG. 4, a value of N may be equal to 1. That is, the accommodation space 220 of the ionization chamber 210 may be provided with only one VDMOS device 100. The gate electrode of one VDMOS device 100 may receive the positive charge through a reverse electric field of the ionization chamber, so as to form the preset voltage V₀ at the gate electrode of the VDMOS device.

For example, referring to FIG. 5, the value of N may be greater than or equal to 2. That is, the accommodation space 220 of the ionization chamber 210 may be provided with a plurality of VDMOS devices 100. Gate electrodes of at least part of the N VDMOS devices receive the positive charge; or the gate electrode of each of the N VDMOS devices receives the positive charge, such that a detection upper limit may be increased in a subsequent radiation dose detection.

For example, referring to FIG. 5, the gate electrodes of the N VDMOS devices 100 may be cascaded by a conductive metal wire 150. The metal wire 150 may receive a positive charge and inject the positive charge into the gate electrode of at least one VDMOS device 100. Through such a design, an efficiency of injecting the positive charge into the gate electrode of the VDMOS device 100 may be improved.

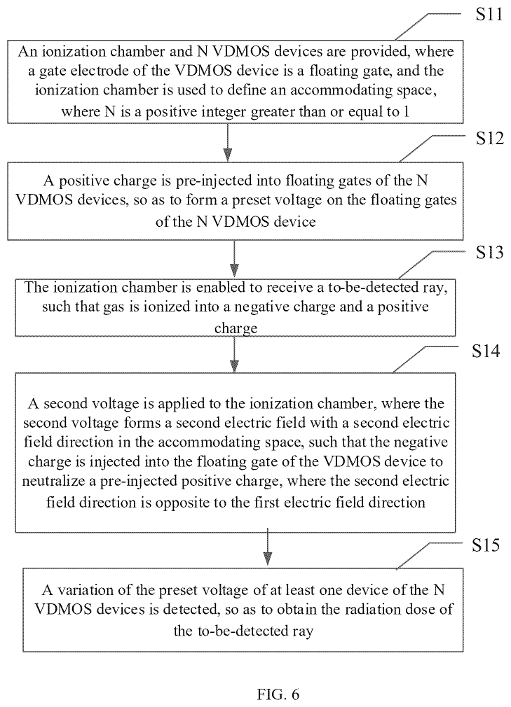

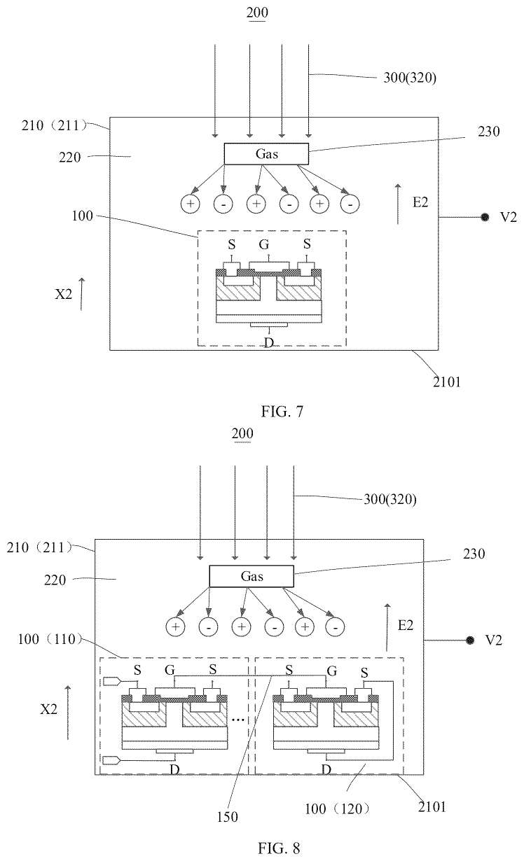

FIG. 6 is a flowchart of a method of detecting a radiation dose according to embodiments of the present disclosure; FIG. 7 is a schematic plan view of an apparatus of detecting a radiation dose for detecting a ray according to embodiments of the present disclosure; and FIG. 8 is a schematic plan view of an apparatus of detecting a radiation dose for detecting a ray according to other embodiments of the present disclosure.

For example, in embodiments of the present disclosure, a method of detecting radiation dose is provided with reference to FIG. 6 to FIG. 8. The method may include the following steps S11 to S15.

In the step S11, the ionization chamber 210 and the N VDMOS devices 100 are provided. The gate electrode G of the VDMOS device 100 is a floating gate, the ionization chamber 210 is used to define the accommodation space 220, where N is a positive integer greater than or equal to 1.

In the step S12, referring to FIG. 5, the positive charge is pre-injected into floating gates of the N VDMOS devices 100 by using the method of injecting a charge into a VDMOS device provided in any one of the above-mentioned embodiments, so as to form the preset voltage V₀ on the floating gates of the N VDMOS devices.

In the step S13, referring to FIG. 7, the ionization chamber 210 is enabled to receive the to-be-detected ray 320, such that the gas 230 is ionized into a negative charge and a positive charge.

For example, a type of the to-be-detected ray 320 and a type of the ray 310 for the gate charge injection of the VDMOS device 100 may be the same or different.

In the step S14, referring to FIG. 7, a second voltage V2 is applied to the ionization chamber 210. The second voltage V2 is used to form a second electric field E2 with a second electric field direction X2 in the accommodation space 220. Under an action of the second electric field E2, the negative charge moves in a direction close to the gate electrode G of the VDMOS device, such that the negative charge is injected into the floating gate of the VDMOS device, so as to neutralize the positive charge pre-injected in the step S12. The second electric field direction X2 is opposite to the first electric field direction X1.

In the step S15, a variation of the preset voltage V₀ of at least one of the N VDMOS devices is detected, so as to obtain the radiation dose of the to-be-detected ray 320.

By changing a direction of the external electric field applied to the ionization chamber, movement directions of the negative charge and the positive charge in the accommodation space may be controlled. For example, when the first voltage V1 is applied to the ionization chamber, the positive charge may be controlled to move towards the gate electrode G of the VDMOS device, such that the positive charge is injected into the gate electrode G of the VDMOS device to form a preset voltage. When the second voltage V2 is applied to the ionization chamber, the negative charge may be controlled to move towards the gate electrode G of the VDMOS device to neutralize a pre-injected positive charge. The first voltage V1 and the second voltage V2 may be reverse voltages. That is, the first electric field direction X1 of the first electric field E1 formed by the first voltage V1 in the accommodation space is opposite to the second electric field direction X2 of the second electric field E2 formed by the second voltage V2 in the accommodation space.

Through such a design, a gate electrode charge injection and a radiation dose detection may be achieved in the integrated apparatus 200 of detecting a radiation dose, which requires a simple operation and does not need to replace the VDMOS device, thereby saving a cost.

For example, a voltage value of the second voltage V2 is in a range of V to 10 V.

For example, the voltage value of the second voltage V2 may be substantially equal to the voltage value of the first voltage V1. The “substantially equal” means that a ratio of the voltage value of the second voltage V2 to the voltage value of the first voltage V1 is in a range of 0.8 to 1.2. For example, the first voltage V1 is +6 V and the second voltage V2 is −6 V. The first voltage V1 and the second voltage V2 may be reverse voltages.

For example, “detecting a variation of the preset voltage V₀ of at least one of the N VDMOS devices to obtain the radiation dose of the to-be-detected ray 320” in the step S15 may include: detecting a change of a source-drain reverse current-voltage curve of at least one of the N VDMOS devices, so as to obtain the radiation dose of the to-be-detected ray 320.

In some embodiments, referring to FIG. 7, the value of N may be 1. “Detecting variation of the preset voltage V₀ of at least one of the N VDMOS devices” in the step S15 may include: detecting a change of the source-drain reverse current-voltage curve of one VDMOS device, so as to obtain the radiation dose of the to-be-detected ray 320.

In some embodiments, referring to FIG. 8, the value of N may be greater than or equal to 2. More than two VDMOS devices 100 are packaged into the accommodation space 220, and the gate electrodes of more than two VDMOS devices 100 are connected in cascade. For example, the gate electrodes of the N VDMOS devices 100 are cascaded by the metal wire 150, where the metal wire 150 is conductive and is placed in the accommodation space 220.

For example, an electron is received by the metal wire 150 and the gate electrode of each VDMOS device 100, so as to cause the change of the source-drain reverse current-voltage curve of each VDMOS device 100.

For example, the N VDMOS devices may include a main VDMOS device 110 and N-1 auxiliary VDMOS devices 120. The radiation dose of the to-be-detected ray 320 may be obtained from the source-drain reverse current-voltage curve of the main VDMOS device 110 before and after a change.

In some embodiments, a source electrode and a drain electrode of each auxiliary VDMOS device 120 are short-circuited. The apparatus 200 of detecting a radiation dose forms a charge collection region by cascading a plurality of VDMOS devices, where the plurality of VDMOS devices are cascaded, and a plurality of VDMOS gate electrodes are cascaded by the metal wire, so as to improve a collection efficiency.

In embodiments of the present disclosure, the accommodation space of the ionization chamber may be filled with various types of gases to detect a plurality of different types of rays.

According to embodiments of the present disclosure, a low-dose (μSv-level) dose detection may be achieved by combining the ionization chamber and the VDMOS technology. Compared with a traditional TLD technology, a radiation dosimeter combining the ionization chamber and the VDMOS technology directly outputs an electrical signal, and is easily combined with electronic hardware, which may achieve a miniaturization and systematization and reduce a specialized thermos-luminescence radiation dose detection system. At the same time, by using a reversal of the external electric field of the ionization chamber, the gate charge injection and the radiation dose detection may be achieved in the integrated apparatus 200 of detecting a radiation dose, and it is not required to use a specialized VDMOS device manufacturing process to inject a charge, which may reduce a process difficulty, especially reducing a process requirement for the gate oxide insulating layer in the VDMOS device, and it is not required to replace the VDMOS device regularly, which may save a cost. Furthermore, through such a design, a variation of the preset voltage may be monitored during radiation charge injection, such that an injected charge amount may be accurately determined and an accurate charge injection may be achieved.

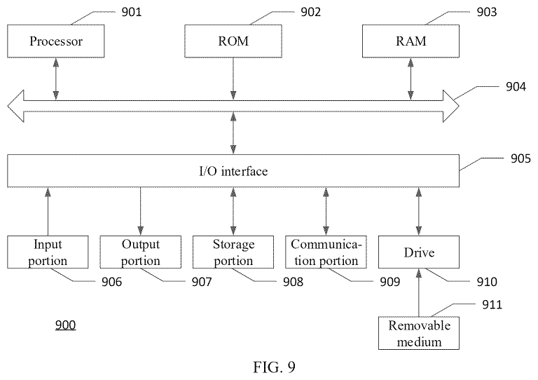

FIG. 9 schematically shows a block diagram of an electronic device suitable for implementing a method of injecting a charge into a VDMOS device or a method of detecting a radiation dose according to embodiments of the present disclosure. The electronic device shown in FIG. 9 is only an example, and should not be intended to limit the function and scope of use of embodiments of the present disclosure.

As shown in FIG. 9, an electronic device 900 according to embodiments of the present disclosure includes a processor 901, which may perform various appropriate actions and processes according to a program stored in a read only memory (ROM) 902 or a program loaded from a storage portion 908 into a random access memory (RAM) 903. The processor 901 may include, for example, a general-purpose microprocessor (such as a CPU), an instruction set processor and/or a related chipset and/or a dedicated-purpose microprocessor (such as an application specific integrated circuit (ASIC)), etc. The processor 901 may also include an on-board memory for caching purposes. The processor 901 may include a single processing unit or a plurality of processing units for performing different actions of a method flow according to embodiments of the present disclosure.

In the RAM 903, various programs and data required for an operation of the electronic device 900 are stored. The processor 901, the ROM 902 and the RAM 903 are connected to each other via a bus 904. The processor 901 performs various operations of the method flow according to embodiments of the present disclosure by executing programs in the ROM 902 and/or RAM 903. It should be noted that the programs may also be stored in one or more memories other than the ROM 902 and RAM 903. The processor 901 may also perform various operations of the method flow according to embodiments of the present disclosure by executing the programs stored in the one or more memories.

According to embodiments of the present disclosure, the electronic device 900 may also include an input/output (I/O) interface 905, which is also connected to the bus 904. The electronic device 900 may also include one or more of the following components connected to the I/O interface 905: an input portion 906 including a keyboard, a mouse, etc.; an output portion 907 such as a cathode ray tube (CRT), a liquid crystal display (LCD), etc., and a loudspeaker, etc.; a storage portion 908 including a hard disk, etc.; and a communication portion 909 including a network interface card such as a LAN card, a modem, etc. The communication portion 909 performs communication processing via a network such as the Internet. A drive 910 is also connected to the I/O interface 905 as required. A removable medium 911, such as a magnetic disk, optical disk, magneto-optical disk, semiconductor memory, etc., is installed on the drive 910 as required, such that computer programs read therefrom may be installed into the storage portion 908 as required.

According to embodiments of the present disclosure, the method flow according to embodiments of the present disclosure may be implemented as a computer software program. For example, embodiments of the present disclosure include a computer program product, which includes a computer program loaded on a computer-readable storage medium, and the computer program includes a program code for performing the method shown in the flowchart. In the embodiment, the computer program may be downloaded and installed from the network through the communication portion 909, and/or installed from the removable medium 911. When the computer program is executed by the processor 901, the above-mentioned functions defined in the system of embodiments of the present disclosure are performed. According to embodiments of the present disclosure, the system, device, apparatus, module, unit, etc. as described above may be achieved by a computer program module.

The present disclosure further provides a computer-readable storage medium, which may be included in the device/apparatus/system described in the above-mentioned embodiment; the computer-readable storage medium may also exist alone without being assembled into the device/apparatus/system. The above-mentioned computer-readable storage medium carries one or more programs. The one or more programs, when executed, implement the method according to embodiments of the present disclosure.

According to embodiments of the present disclosure, the computer-readable storage medium may be a nonvolatile computer-readable storage medium. For example, it may include, but is not limited to, a portable computer disk, a hard disk, a random access memory (RAM), a read-only memory (ROM), an erasable programmable read-only memory (EPROM or a flash memory), a portable compact disk read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus or device.

For example, according to embodiments of the present disclosure, the computer-readable storage medium may include the ROM 902 and/or RAM 903 as described above and/or one or more memories other than the ROM 902 and the RAM 903 as described above.

Embodiments of the present disclosure further provide a computer program product including a computer program, where the computer program contains a program code for executing the method provided in embodiments of the present disclosure. When the computer program product runs on an electronic device, the program code is used to cause the electronic device to implement the method of injecting a charge into a VDMOS device or the method of detecting a radiation dose provided in embodiments of the present disclosure.

When the computer program is executed by the processor 901, the above-mentioned functions defined in the system/apparatus of embodiments of the present disclosure are executed. According to embodiments of the present disclosure, the system, apparatus, module, unit, etc. described above may be implemented by the computer program module.

In an embodiment, the computer program may rely on tangible storage media such as an optical storage device, a magnetic storage device, etc. In another embodiment, the computer program may also be transmitted and distributed in a form of a signal on a network medium, and downloaded and installed through the communication portion 909, and/or installed from the removable medium 911. The program code contained in the computer program may be transmitted by any suitable network medium, including but not limited to: wireless, wired, etc., or any suitable combination thereof.

According to embodiments of the present disclosure, the program code for executing the computer program provided in embodiments of the present disclosure may be written in any combination of one or more programming languages, and specifically, these calculation programs may be implemented by using a high-level procedural and/or object-oriented programming language and/or an assembly/machine language. The programming languages include but are not limited to Java, C++, python, “C” language or similar programming languages. The program code may be completely executed on a user computing device, partially executed on a user device, partially executed on a remote computing device, or completely executed on a remote computing device or server. In a case of involving the remote computing device, the remote computing device may be connected to the user computing device through any type of network, including a local area network (LAN) or a wide area network (WAN), or may be connected to an external computing device (e.g., through the Internet using an Internet service provider).

The above one or more embodiments have the following advantages: by using method of injecting a charge by ionization, a gate oxide requirement may be reduced, and factors such as a thickness and a quality of an oxide layer, etc. do not need to be considered, thereby reducing a manufacturing difficulty of the VDMOS device, and the manufacturing may be completed by using a standard VDMOS process. By adding a selection path to the ionization chamber, a voltage may be adjusted hierarchically. Charge injection may be achieved by using a reverse polarity of power supply for a dosimeter ionization chamber, which may perfectly solve a problem of gate charge injection under a condition of dosimeter integration. By monitoring a variation of the preset voltage during radiation charge injection, an amount of injected charges may be accurately determined, so as to achieve an accurate charge injection.

The flowcharts and block diagrams in the accompanying drawings illustrate possibly implemented architectures, functions and operations of the systems, methods and computer program products according to various embodiments of the present disclosure. In this regard, each block in the flowcharts or block diagrams may represent a module, a program segment, or part of a code. The above-mentioned module, program segment, or part of the code contains one or more executable instructions for realizing specified logic functions. It should also be noted that in some alternative implementations, functions marked in the blocks may also occur in a different order from those marked in the accompanying drawings. For example, two consecutive blocks may actually be performed in parallel, and sometimes they may be performed in a reverse order, which depends on the functions involved. It should also be noted that each block in the block diagrams or flowcharts and a combination of blocks in the block diagrams or flowcharts may be implemented by a dedicated hardware-based system that performs specified functions or operations, or by a combination of a dedicated hardware and computer instructions. Those skilled in the art will appreciate that various combinations and/or incorporations of features recited in various embodiments of the present disclosure may be made, even if such combinations or incorporations are not explicitly recited in the present disclosure. In particular, without departing from the spirit and principles of the present disclosure, various combinations and/or incorporations of the features recited in the various embodiments of the present disclosure may be made. All of the combinations and/or incorporations fall within the scope of the present disclosure.

Embodiments of the present disclosure have been described above. However, these embodiments are for illustrative purposes only, and are not used to limit the scope of the present disclosure. Although embodiments are described separately above, this does not mean that the measures in various embodiments may not be used advantageously in combination. Without departing from the scope of the present disclosure, those skilled in the art may make various alternatives and modifications, and these alternatives and modifications should all fall within the scope of the present disclosure.

What is claimed is:

1. A method of injecting a charge into a VDMOS device, comprising:
arranging N VDMOS devices in an ionization chamber, wherein a gate electrode of the VDMOS device is a floating gate, the ionization chamber is configured to define an accommodation space, and N is a positive integer greater than or equal to 1;
filling the accommodation space with gas, wherein the gas is configured to react with a ray entering the accommodation space to generate a negative charge and a positive charge;
providing the ray to the ionization chamber, such that the gas is ionized into the negative charge and the positive charge; and
applying a first voltage to the ionization chamber, wherein the first voltage is configured to form a first electric field with a first electric field direction in the accommodation space, such that the positive charge is injected into the floating gate of the VDMOS device, wherein the first electric field direction is a direction in which the floating gate towards a bottom surface of the ionization chamber.

2. The method according to claim 1, wherein a voltage value of the first voltage is in a range of 5 V to 10 V.

3. The method according to claim 1, wherein when a value of N is greater than or equal to 2, gate electrodes of at least part of the N VDMOS devices are configured to receive the positive charge.

4. The method according to claim 3, wherein the gate electrodes of the N VDMOS devices are cascaded by a conductive metal wire, and the metal wire is configured to receive the positive charge and inject the positive charge into the gate electrode of at least one VDMOS device.

5. A method of detecting a radiation dose, comprising:
providing an ionization chamber and N VDMOS devices, wherein a gate electrode of the VDMOS device is a floating gate, the ionization chamber is configured to define an accommodation space, and N is a positive integer greater than or equal to 1;
pre-injecting a positive charge into floating gates of the N VDMOS devices by using the method according to claim 1, so as to form a preset voltage on the floating gates of the N VDMOS devices;
enabling the ionization chamber to receive a to-be-detected ray, such that gas is ionized into a negative charge and a positive charge;
applying a second voltage to the ionization chamber, wherein the second voltage is configured to form a second electric field with a second electric field direction in the accommodation space, such that the negative charge is injected into the floating gate of the VDMOS device to neutralize a pre-injected positive charge, wherein the second electric field direction is opposite to the first electric field direction; and
detecting a variation of the preset voltage of at least one of the N VDMOS devices to obtain a radiation dose of the to-be-detected ray.

6. The method according to claim 5, wherein a voltage value of the second voltage is in a range of 5 V to 10 V.

7. The method according to claim 5, wherein a voltage value of the second voltage is substantially equal to a voltage value of the first voltage.

8. The method according to claim 5, wherein the detecting a variation of the preset voltage of at least one of the N VDMOS devices to obtain a radiation dose of the to-be-detected ray comprises:
detecting a change of a source-drain reverse current-voltage curve of at least one of the N VDMOS devices, so as to obtain the radiation dose of the to-be-detected ray.

9. The method according to claim 8, wherein when a value of N is greater than or equal to 2, the N VDMOS devices comprise a main VDMOS device and N-1 auxiliary VDMOS devices; and
wherein the radiation dose of the to-be-detected ray is obtained by the source-drain reverse current-voltage curve of the main VDMOS device before and after a change.

10. An electronic device, comprising:
one or more processors; and
a memory configured to store one or more programs,
wherein the one or more programs, when executed by the one or more processors, are configured to cause the one or more processors to implement the method of injecting a charge into a VDMOS device according to claim 1.

11. An electronic device, comprising:
one or more processors; and
a memory configured to store one or more programs,
wherein the one or more programs, when executed by the one or more processors, are configured to cause the one or more processors to implement the method of detecting a radiation dose according to claim 5.

12. A computer-readable storage medium having computer-executable instructions stored therein, wherein the instructions, when executed, are configured to implement the method of injecting a charge into a VDMOS device according to claim 1.

13. A computer-readable storage medium having computer-executable instructions stored therein, wherein the instructions, when executed, are configured to implement the method of detecting a radiation dose according to claim 5.

14. A computer program product comprising a computer program, wherein the computer program, when executed by a processor, is configured to implement the method of injecting a charge into a VDMOS device according to claim 1.

15. A computer program product comprising a computer program, wherein the computer program, when executed by a processor, is configured to implement the method of detecting a radiation dose according to claim 5.
